(19) United States
(12) Patent Application Publication
(10) Pub. No.: US 2009/0014904 A1
(43) Pub. Date: Jan. 15, 2009

(54) Method of producing a baluster component made of recycled material

(76) Inventor: Min-Ju Chung, Tan-Tzu Hsiang (TW)

Correspondence Address: LADAS & PARRY, 5670 WILSHIRE BOULEVARD, SUITE 2100, LOS ANGELES, CA, 90036-5679, US

(21) Appl. No.: 11/825,906

(22) Filed: Jul. 9, 2007

(51) Int. Cl. B28B 17/00

(52) U.S. Cl. 264/162

(57) ABSTRACT

A method of producing a baluster component includes the steps of: (A) blending wood flour with a resin to form a wood flour composition; (B) filling a mold with the wood flour composition to form a semi-finished baluster component; (C) polishing the semi-finished baluster component; and (D) providing an outer surface of the semi-finished baluster component with a coating layer after polishing to form the baluster component.

### BACKGROUND OF THE INVENTION

1. Field of the Invention

This invention relates to a method of producing a structural element used in residential and commercial buildings, more particularly to a method of producing a baluster component made of recycled material.

2. Description of the Related Art

Referring to FIG. 1, a conventional baluster 1 made of wood, in order to achieve the purpose of beautifying the design of the entire body, includes a bottom connecting section 101 having a rectangular cross section and fixed to flooring 50 (shown in phantom lines), a tapered connecting section 102 fixed to a bottom portion of a handrail 60 (shown in phantom lines), and a decorative section 103 connected between the bottom and tapered connecting sections 101, 102. The bottom connecting section 101 has one end provided with a tenon 104. Through the different designs of the portions of the baluster 1, the baluster 1 is provided with an elegant and attractive appearance.

Although the conventional baluster 1 is widely used, because the baluster 1 is entirely made of wood, production of the baluster 1 requires the wood material to be turned in a wood lathe to form the desired design. Such a process is difficult to perform and results in large waste of wood material.

### SUMMARY OF THE INVENTION

Therefore, the object of the present invention is to provide a method of producing a baluster component that utilizes a minimal amount of wood material, that can minimize processing cost, and that can produce the baluster component so that it has the quality and strength of wood.

According to one aspect of this invention, a method of producing a baluster component comprises the steps of: (A) blending wood flour with a resin to form a wood flour composition; (B) filling a mold with the wood flour composition to form a semi-finished baluster component; (C) polishing the semi-finished baluster component; and (D) providing an outer surface of the semi-finished baluster component with a coating layer after polishing to form the baluster component.

According to another aspect of this invention, a method of producing a baluster component comprises the steps of: (A) blending wood flour with a resin to form a wood flour composition; (B) filling a mold with the wood flour composition to form a semi-finished baluster component; (C) machining a portion of the semi-finished baluster component to form a pattern; (D) polishing the semi-finished baluster component; and (E) providing an outer surface of the semi-finished baluster component with a coating layer after polishing to form the baluster component.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a sectional view of a conventional baluster;

FIG. 2 is a flow chart illustrating the steps involved in a method of producing a baluster component according to the first preferred embodiment of the present invention;

FIG. 3 is a sectional view, illustrating a mold step involved in the first preferred embodiment;

FIG. 4 is a sectional view of a semi-finished baluster component made according to the first preferred embodiment;

FIG. 5 is a sectional view of the baluster component made according to the first preferred embodiment;

FIG. 6 is a fragmentary sectional view of a semi-finished baluster component produced according to the second preferred embodiment of the present invention; and

FIG. 7 is a fragmentary sectional view of the baluster component made according to the second preferred embodiment.

### DETAILED DESCRIPTION OF THE PREFERRED EMBODIMENTS

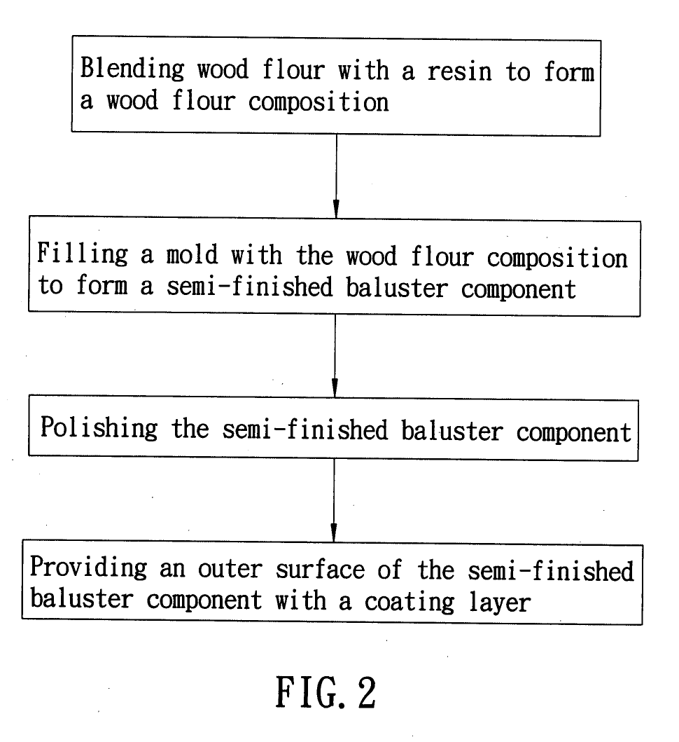

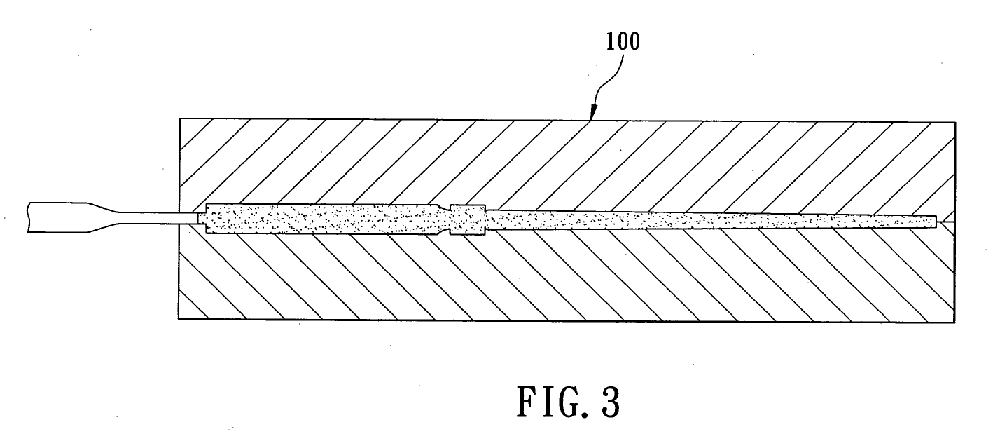

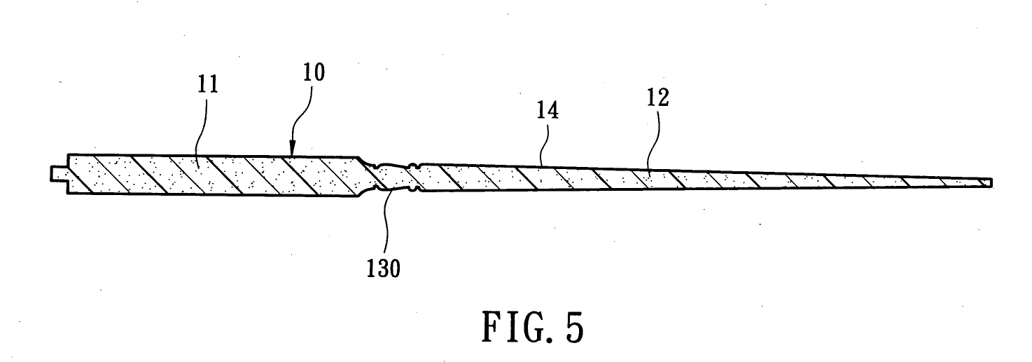

FIG. 2 illustrates the steps involved in a method of producing a baluster component 10 (see FIG. 5) according to the first preferred embodiment of the present invention. These steps will be described in greater detail below, in combination with FIGS. 3 to 5.

In step (A), wood flour and a plastic resin are melted and blended in a predetermined mixing ratio to form a wood flour composition. The wood flour composition includes 50˜70% by weight of the wood flour and 30˜50% by weight of the plastic resin. In this embodiment, the plastic resin may be polyethylene (PE).

In step (B), with reference to FIG. 3, the wood flour composition is filled in to a mold 100 by an injection process. Alternatively, the wood flour composition may be filled into the mold 100 by extrusion.

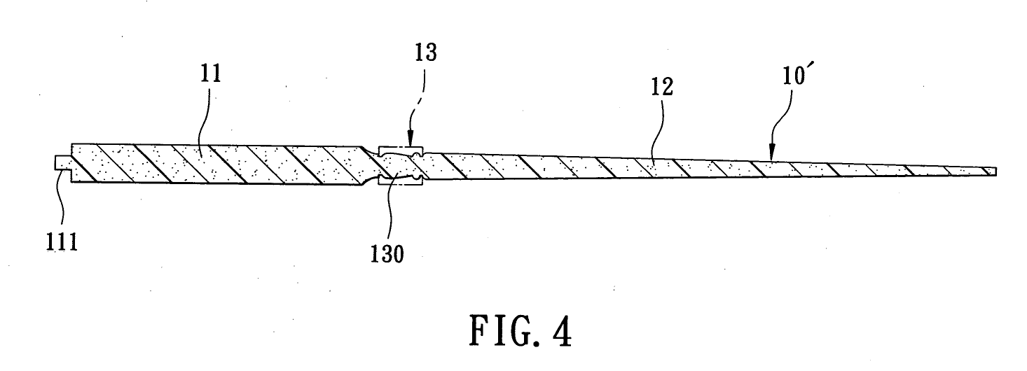

In step (C), with reference to FIG. 4, the mold 100 is opened when the wood flour composition is solidified and is formed into a semi-finished baluster component 10′. The semi-finished baluster component 10′ includes a first portion 11, a second portion 12, and an intermediate portion 13 (shown in phantom lines) connected between the first and second portions 11, 12. The first and intermediate portions 11, 13 have a square-shaped cross section. The first portion 11 has a tenon 111 projecting longitudinally from the first portion 11 and opposite to the second portion 12. The second portion 12 is tapered longitudinally.

Continuing with step (C), the semi-finished baluster component 10′ is subsequently removed from the mold 100, then outer surfaces of the first and second portions 11, 12 of the semi-finished baluster component 10′ are polished, while the intermediate portion 13 thereof is machined to form a pattern 130 of a desired design. The intermediate portion 13 of the present invention maybe formed with grooves, protrusions, or curved surfaces.

Finally, in step (D), with reference to FIG. 5, a coating layer 14 is provided on the outer surfaces of the first, second, and intermediate portions 11, 12, 13 of the semi-finished baluster component 10′ to form the finished baluster component 10 of the present invention. The coating layer 14 is formed of a polyurethane (PU) coating, and includes a primer coat and a surface coat.

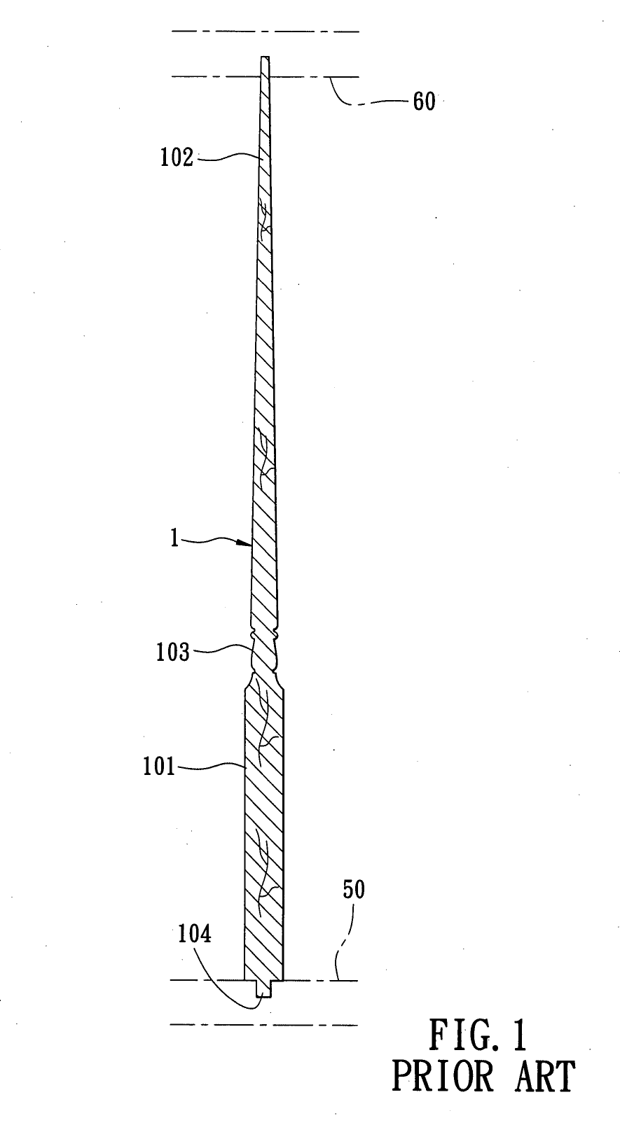

Since the baluster component 10 of the present invention is made by a molding process, the semi-finished baluster component 10′ removed from the mold 100 is already near to completion. In order to complete the baluster component 10 of the present invention, the semi-finished baluster component 10′ has only to undergo machining of the intermediate portion 13 thereof to form the pattern 130, polishing of the outer surfaces of the first and second portions 11, 12 thereof, and finally, application of the primer coat and the surface coat to the outer surfaces of the first, second, and intermediate portions 11, 12, 13 thereof to form the coating layer 14. There is no need for other processing steps. Hence, the making and processing of the baluster component 10 of the present invention are relatively easy. The quality and strength of the entire baluster component 10 can be as good as the aforementioned conventional baluster 1 (see FIG. 1) which is entirely made of wood.

Further, the method of producing the baluster component 10 of the present invention utilizes blending of the wood flour and the PE plastic resin to form the wood flour composition so as to enhance its strength, and so that not only consumption and waste of wood material can be minimized, the waste (wood flour) produced during wood processing can also be recycled. This is highly beneficial to the protection of the environment. Moreover, through the plastic molding process, the processing cost of the present invention is reduced when compared to conventional configuration requiring significantly more processing.

Additionally, the method of the present invention utilizes a common mold 100, and the intermediate portion 13 of the semi-finished baluster component 10′ is produced to have a square-shaped cross section, after which the intermediate portion 13 is machined to form the desired pattern 130. Alternatively, a mold of particular specifications may be used, so that the intermediate portion 13 may be directly formed with the desired pattern 130, in which case the next (and final) step would consist only of polishing the outer surfaces of the first, second, and intermediate portions 11, 12, 13.

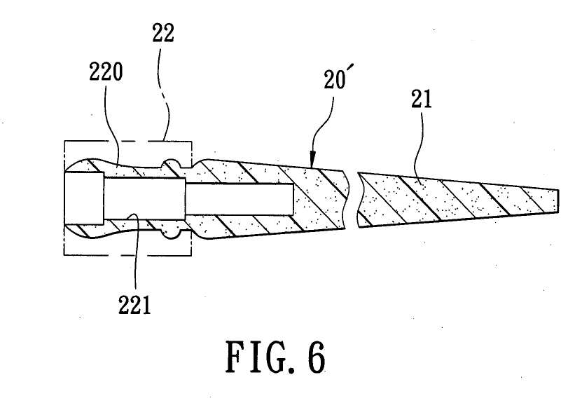

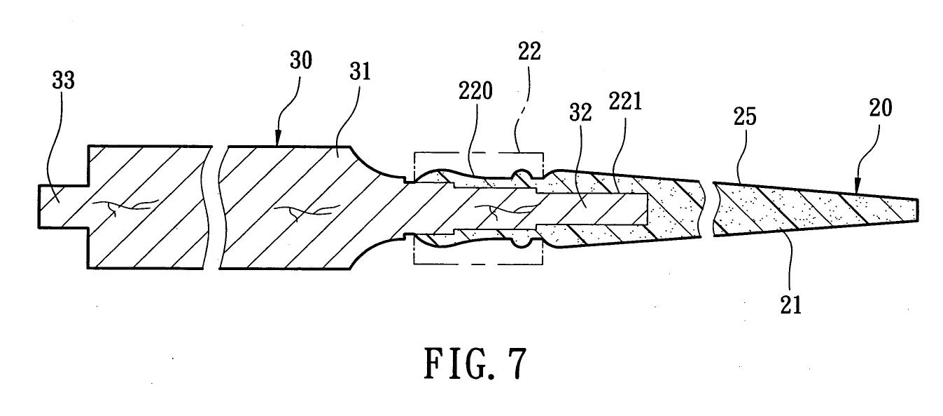

Referring to FIGS. 6 and 7, a baluster component 20 produced according to the second preferred embodiment of the present invention is shown to be similar to the first preferred embodiment. However, in this embodiment, the semi-finished baluster component 20′ removed from the mold 100 (see FIG. 3) in step (C) includes a tapered end portion 21, and a connecting end portion 22 connected to one side of the tapered end portion 21 and having an inner stepped wall 221 that confines a hole. The connecting end portion 22 is then machined to form a desired pattern 220, and an outer surface of the tapered end portion 21 is polished. Finally, a coating layer 25 is provided on the outer surfaces of the tapered end portion 21 and the connecting end portion 22 of the semi-finished baluster component 20′ to form the baluster component 20 of the present invention. The baluster component 20 can then be connected with another baluster component 30 made of wood. The baluster component 30 has a first section 31 with a square-shaped cross section, a second section 32 projecting from one end of the first section 31 and having a stepped configuration, and a tenon 33 that projects longitudinally from the other end of the first section 31 opposite to the second section 32. The second section 32 of the baluster component 30 is engaged to the inner stepped wall 221 of the connecting end portion 22 so as to interconnect the baluster components 20, 30 to form a baluster.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

I claim:

1. A method of producing a baluster component, comprising:
(A) blending wood flour with a resin to form a wood flour composition;
(B) filling a mold with the wood flour composition to form a semi-finished baluster component;
(C) polishing the semi-finished baluster component; and
(D) providing an outer surface of the semi-finished baluster component with a coating layer after polishing to form the baluster component.

2. The method of claim 1, further comprising the step of machining an intermediate portion of the semi-finished baluster component to form a pattern before step (C).

3. The method of claim 1, further comprising the step of machining an end portion of the semi-finished baluster component to form a pattern before step (C).

4. The method of claim 1, wherein the coating layer is formed of a polyurethane (PU) coating.

5. The method of claim 1, wherein the wood flour composition includes 50˜70% by weight of the wood flour and 30˜50% by weight of the resin.

6. A method of producing a baluster component, comprising:
(A) blending wood flour with a resin to form a wood flour composition;
(B) filling a mold with the wood flour composition to form a semi-finished baluster component;
(C) machining a portion of the semi-finished baluster component to form a pattern;
(D) polishing the semi-finished baluster component; and
(E) providing an outer surface of the semi-finished baluster component with a coating layer after polishing to form the baluster component.

7. The method of claim 6, wherein the portion of the semi-finished baluster component machined to form a pattern is an intermediate portion of the semi-finished baluster component.

8. The method of claim 6, wherein the portion of the semi-finished baluster component machined to form a pattern is an end portion of the semi-finished baluster component.
